(19) United States
(12) Patent Application Publication
(10) Pub. No.: US 2026/0080298 A1
(43) Pub. Date: Mar. 19, 2026

(54) COMPLEX ORGANIZATION INTAKE ARTIFICIAL INTELLIGENCE WORKFLOW IMPROVEMENTS

(71) Applicants: Leah D. Guinyard, Midlothian, TX (US); Mojgan Madadi, San Mateo, CA (US); Michelle L. Mercado, Las Vegas, NV (US); Caleb Jordan Parker, Saint Charles, MO (US)

(72) Inventors: Leah D. Guinyard, Midlothian, TX (US); Mojgan Madadi, San Mateo, CA (US); Michelle L. Mercado, Las Vegas, NV (US); Caleb Jordan Parker, Saint Charles, MO (US)

(21) Appl. No.: 18/885,000

(22) Filed: Sep. 13, 2024

(51) Int. Cl. G06N 20/00; G06F 40/35

(52) U.S. Cl. CPC G06N 20/00; G06F 40/35

(57) ABSTRACT

A system for optimizing complex data intake processes using a machine learning trained model. The system receives user input, determines user intention, and identifies relevant data fields. The system generates a prompt to elicit a data entry, extracts information from a user response or an uploaded document, and optionally performs real-time verification. The system integrates natural language processing, image recognition, or data classification functionalities to guide users through complex processes. The system cross-references extracted data with existing records, classifies the data entry into an appropriate data field, or stores verified data in a database. The system enhances accuracy, reduces errors, and improves efficiency in handling complex document processing or data management tasks.

### TECHNICAL FIELD

Embodiments described herein generally relate to machine learning and, in some embodiments, more specifically to an artificial intelligence (AI) conversational system for data intake.

### BACKGROUND

A computing system may perform automated interaction with a user. The user may enter text into a graphical user interface and the computing system may provide a response in the graphical user interface. The response may be based on keywords identified in the text entered by the user. The interaction with the computing system may assist the user in completing a user intention.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of an example of an environment 100 for performing data intake, according to some examples.

FIG. 2 is a conceptual diagram of the training architecture for training a machine learning trained model, according to some examples.

FIG. 3 is a flowchart illustrating an example method 300 for data intake using the machine learning trained model, according to some examples.

FIG. 4 is a flowchart illustrating an example method 400 for remedying deficiencies, according to some examples.

FIG. 5 is a flowchart illustrating an example method 500 for extracting data entries from an image, according to some examples.

FIG. 6 is a flowchart illustrating an example method 600 for improving the accuracy of the data intake, according to some examples.

FIG. 7 is a conceptual diagram illustrating an example interaction between a customer and the system, according to some examples.

FIG. 8 is a diagrammatic representation of a machine in the form of a computer system within which a set of instructions may be executed for causing the machine to perform any one or more of the methodologies discussed herein, according to some examples.

### DETAILED DESCRIPTION

The present disclosure relates to a system designed to optimize data intake processes. The system implements a machine learning trained model to facilitate user interactions, perform information extraction and classification, and input relevant data entries under different data fields of a database. In some examples, the system is configured to assist a human operator who provides services to users. For example, the system assists the human operator, who is a banking professional, performing a task associated with a user intention.

The machine learning trained model may be trained to engage in an interactive dialogue with the users, generating a contextually appropriate prompt or a follow-up prompt to elicit requisite information. This includes AI-driven dynamic questioning to guide the users through the data collection process by generating layered, probing questions based on previous responses to accurately intake user information and other relevant details.

The machine learning trained model utilized by the system may be trained to analyze user inputs to discern user intentions. The machine learning trained model may extract pertinent data entries from the user inputs. The machine learning trained model may map the data entries to appropriate data fields within a customer database. The machine learning trained model may be trained to interpret a document, such as a trust document and a fillable form. The machine learning trained model may be trained to fill in a blank on the fillable form. In some examples, filling in the blank typically requires specialized knowledge; the machine learning trained model is trained to fill in the blank of the fillable form, thereby reducing the burden on human operators and minimizing the need for them to call for assistance.

By implementing AI-driven dynamic questioning and real-time document analysis, the systems and techniques described herein mitigate errors or reduce time-consuming follow-up procedures. The system is configured to analyze scanned documents and cross-reference information such as names or ownership details to ensure consistency and accuracy. The system may perform checks in response to document scanning, rather than waiting for post-transaction error detection. The system may seek information from multiple sources to validate customer information.

In some examples, the machine learning trained model utilized by the system includes natural language processing capabilities for interpreting a document, real-time cross-referencing of information, or an assistance provision for a user navigating a detailed process. The machine learning trained model may include a continuous learning algorithm enabling model adaptation or improvement over time. The architecture of the machine learning trained model ensures relevance and efficacy while maintaining data security.

By automating and optimizing data intake and verification processes, the present systems and techniques provide technical improvements in data intake technology. These may include improving data accuracy and security, generating language based on context, designing an improved sequence of data intake by asking targeted prompts or follow-up prompts, or automating complex documentation interpretation, reducing the need for specialized human knowledge or assistance. The system improves the process of data intake and may optimize the user experience for both customers and banking professionals.

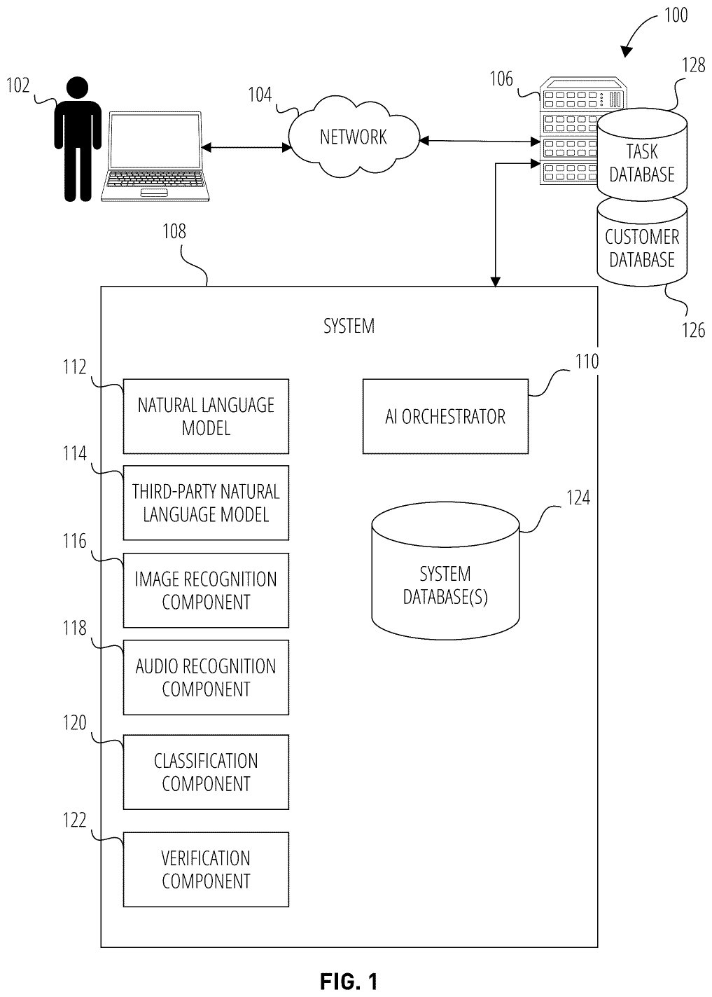

FIG. 1 is a block diagram of an example of an environment 100 for performing data intake, according to some examples. The environment 100 may include a user 102 interacting with an interactive channel provider 106 via a network 104 (e.g., wired network, wireless network, the internet, a cellular network, etc.). In some examples, the interactive channel provider 106 comprises a web domain (e.g., website/web server) communicatively coupled (e.g., via a wired network, wireless network, the internet, cellular network, shared bus, etc.) to the system 108 (e.g., a server, a cloud computing platform, a server cluster, etc.). In some examples, the interactive channel provider 106 may include a customer database 126 that stores customer data 204. In some examples, the customer database 126 comprises a data protection component that may shield private data from being presented to the user 102 without authentication or from being presented to other components within the environment 100 without authorization of the user 102. In some examples, the interactive channel provider 106 includes a task database 128 that stores task information 206.

The user 102 may interact with the system 108 that is configured to intake information based on the user intention of the user 102. In some examples, the user intention is associated with a task related to a product or services provided by the entity hosting the interactive channel provider 106. The system 108 is configured to perform or partially perform the task. For example, the user intention is to open a checking account at the entity hosting the interactive channel provider 106, the task includes collecting customer information needed for opening the checking account, and the system 108 is configured to collect the customer information. In some examples, the user 102 interacts with the system 108 via a graphical user interface (e.g., chat user interface) presented in the webpage provided by the interactive channel provider 106. For example, the interactive channel provider 106 provides a chatbot service enabled by the system 108.

In some examples, the system 108 comprises an AI orchestrator 110, one or more components including a natural language model 112, a third-party natural language model 114, an image recognition component 116, an audio recognition component 118, a classification component 120, a verification component 122, or one or more system databases 124.

In some examples, the AI orchestrator 110 serves as a control unit within the system 108, directing the operational workflows among various components of the system 108. The AI orchestrator 110 determines the activation sequence for each component based on the user inputs. For example, in response to receiving a user input comprising an image and an audio clip, the AI orchestrator 110 causes the image recognition component 116 and the audio recognition component 118 to be activated.

In some examples, the natural language model 112 facilitates user interaction by generating outputs (e.g., prompts, follow-up prompts, and help text) and processing and responding to user inputs (e.g., user responses, user communications, user actions). The natural language model 112 is configured to interpret the semantic and syntactic elements of the user inputs. In some examples, the natural language model 112 dynamically generates outputs based on contextual information of the user inputs, ensuring adaptive dialogue flow. For example, the natural language model 112 generates prompts, follow-up prompts, and help text that include synonyms for words included in the received user inputs. The natural language model 112 may include a variety of components for evaluating user inputs using a variety of machine learning and textual analysis techniques. In some examples, the natural language model 112 is configured to evaluate user inputs to correct typographical errors in the received user inputs before extracting data entries from the user inputs.

In some examples, the third-party natural language model 114 provides an auxiliary processing capability for facilitating user interactions. The third-party natural language model 114 can be a trained transformer model like ChatGPT, offering robust language processing capabilities that supplement or substitute the natural language model 112. Integration of such third-party models allows for scalable and flexible dialogue management, accommodating varying levels of linguistic complexity and user interaction dynamics.

In some examples, the image recognition component 116 employs computer vision technologies to extract information from visual inputs provided by users. Utilizing techniques such as optical character recognition (OCR) and image analysis, the image recognition component 116 converts image-based user inputs, such as documents like identification cards, tax returns, and legal documents, into textual format. The user inputs converted by the image recognition component 116 are in a textual format that can be further processed or stored by other components of the system 108. For example, the user inputs in non-textual formats may be converted and be used in classification component 120. In some examples, the image recognition component 116 utilizes existing Optical Character Recognition (OCR) engines, such as Tesseract or commercial solutions like Google Cloud Vision, to extract textual information from the images.

In some examples, the audio recognition component 118 transcribes (e.g., converts) user inputs comprising spoken language into textual information so that the user inputs may be processed by other components of the system 108. For example, by converting audio user inputs, the audio recognition component 118 allows the classification component 120 to process the user inputs, enabling the system 108 to handle user inputs stemming from multiple communication modalities.

In some examples, the classification component 120 categorizes information (e.g., data entries) extracted from user dialogues. In some examples, classification component applies machine learning algorithms to assign the extracted data entries into specific data fields in the customer database 126. This classification component 120 ensures that data is organized according to relevant data schemas, optimizing data storage, retrieval, and analysis processes. In some examples, self-learning and deep-learning components are included with the classification component 120. The learning components may be provided training data (labeled or unlabeled) that may be processed by the learning components to identify classifications and relationships between input elements and classifications. Models output by the learning components may be used to evaluate the inputs to identify and output entities and intents determined to be included in the input using the models.

In some examples, the classification component 120 classification component that evaluates the extracted information (e.g., extracted data entries) and associates the extracted information with data fields in the customer database 126. For example, the evaluation of a text string may determine that the text string may be classified as an address associated with the user 102. The classification component may evaluate input to identify and output one or more entities or intents included in a user input. A stemming/lemma/named entity recognition (NER) component may process unstructured text in evaluating inputs to identify and output context or meaning of the user input.

In some examples, the verification component 122 validates the accuracy and consistency of information obtained through user interactions. The verification component 122 employs data validation algorithms to perform cross-referencing checks between newly acquired data entries and existing information in the customer database 126. The verification component 122 ensures data integrity and reliability by performing cross-referencing and cross-checks.

In some examples, the system 108 comprises a system database 124 that stores conversation data or feedback and improvement data.

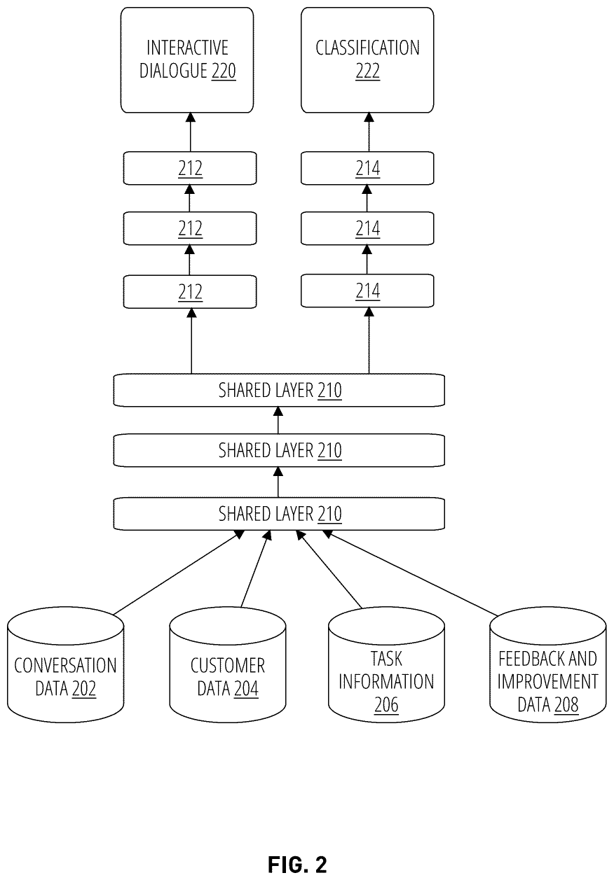

In some examples, a machine learning trained model is configured to perform one or more functionalities of the one or more components within the system 108. The machine learning trained model is discussed with reference to FIG. 2.

FIG. 2 is a conceptual diagram of the training architecture for training the machine learning trained model, according to some examples. In some examples, the machine learning trained model acts as the natural language model 112 and the classification component 120. In some examples, the machine learning trained model are communicatively coupled with the image recognition component 116, audio recognition component 118, and the verification component 122. The machine learning trained model is configured to handle the one or more functionalities such as natural language processing and data classification.

In some examples, the training architecture includes training data (e.g., conversation data 202, customer data 204, task information 206, or feedback and improvement data 208), one or more shared layers (e.g., shared layer 210), and one or more task-specific layers (e.g., first task specific layer 212 and second task specific layer 214) where the machine learning trained model learns to perform one or more functionalities. In some examples, the first task specific layers 212 and second task specific layer 214, respectively, train the machine learning trained model to engage in an interactive dialogue 220 and perform classification 222.

In some examples, the training data comprises conversation data 202. The conversation data 202 includes communication with a customer (e.g., user 102). In some examples, the conversation data 202 comprises a variety of customer queries, requests, and dialogues that occur in banking settings, as well as information that bank representatives may need to communicate to the customers, such as explanations of banking policies, procedures, and information of products and services. In some examples, the conversation data 202 comprises questions, issues, responses, and resolution processes. In some examples, conversation data 202 is generated based on communication between customers and an agent or a bank representative. For example, the conversation data 202 is generated based on call transcripts and chat history. In some examples, the conversation data 202 comprises annotated conversation data indicating user intentions and data entries associated with different data fields. The annotated conversation data helps train the machine learning trained model to recognize, describe, and classify different user intentions and data entries.

In some examples, the training data comprises customer data 204. The customer data 204 comprises various information associated with customers. For example, the customer data 204 comprises customer profiles, account information associated with the customer, demographics, documents uploaded to the customer database 126. In some examples, the customer data 204 are anonymized to protect privacy. In some examples, the system 108 cleans the data to remove irrelevant information and correct inaccuracies and augments the data to cover a wider range of scenarios and language variations. In some examples, in cases in which the customer data 204 are not in textual format, the AI orchestrator 110 causes the image recognition component 116 or the audio recognition component 118 to convert the non-textual customer data 204 to textual format using image recognition techniques or audio recognition techniques. For example, an image of a personal check of a customer is converted to text, the text includes the first and last name of the customer, the address of the customer, the amount of the check, the account number, and the routing number. In some examples, the customer data 204 comprises annotated customer data. The annotated customer data comprise of data entries paired with detailed descriptions or captions. In some examples, the annotated customer data include various types of data entries that appeared in documents uploaded to the customer database 126 (e.g., tax returns, IDs, driver licenses). The data entries may include a first and last name, a driver license number, etc. Each of these data entries may be paired with a detailed annotation. The detailed annotation may include a label indicating to which data fields these data entries belong. The annotated customer data helps train the machine learning trained model to recognize, describe, and classify different data entries.

In some examples, the training data comprises task information 206. The task information 206 may comprise explanatory content related to the products and services offered by the entity hosting the interactive channel provider 106. For example, explanatory content includes frequently asked questions, answers to those frequently asked questions, or help-center articles. In some examples, the explanatory content is organized by different user intentions. In some examples, the task information 206 further comprises explanatory content such as product descriptions, service procedures, or step-by-step guides for services. For example, when the entity hosting the interactive channel provider 106 is a banking service provider, the different user intentions may be associated with account opening, money transfers, and loan applications. In some examples, task information 206 includes a task name associated with a user intention and the corresponding data fields associated with the task in the customer data 204. In some examples, the task information 206 comprises a large set of general documents in addition to the more specific set of documents related to a specific product or service. The large set of general documents helps the machine learning trained model leverage other general knowledge to perform natural language processing while tying the general knowledge with the specific product or service.

In some examples, the training data comprises feedback and improvement data 208. The feedback and improvement data 208 may comprise customer feedback or feedback generated by human operators. The feedback and improvement data 208 may be used to refine the machine learning trained model (e.g., continuously), for example including adjusting the parameters of the machine learning trained model. In some examples, the feedback and improvement data 208 comprises sentiment and intent analysis data that may be used to train the machine learning trained model to understand mood or the user intentions of a customer or other user. The sentiment and intent analysis data may include labeled sentiment data or intent classification data, which may be used to teach the machine learning trained model to recognize different sentiments or user intentions based on the user interactions.

In some examples, a data augmentation technique is applied to increase the diversity of the training data. Data augmentation techniques may include translation or adding noise to simulate different document conditions.

In some examples, the training data are preprocessed before being fed into the shared layer 210. In some examples, the preprocessing of training data includes text normalization, which includes converting all text to lowercase, removing punctuation, or standardizing formatting to ensure consistency across the dataset. In some examples, preprocessing training data includes tokenization, which involves breaking down text into individual words or subwords that can serve as the basic units for further processing. In some examples, the preprocessing training data further comprises removing stop words, eliminating common words such as “the”, “is”, and “and” that typically do not contribute significant meaning to the text. In some examples, the preprocessing training data further comprises stemming or lemmatization to reduce words to their root form, handling variations of the same word. For example, “running”, “runs”, and “ran”are all reduced to “run”.

In some examples, the training data are preprocessed using text augmentation techniques to create variations of the original text while preserving its meaning. This can include methods such as synonym replacement, random insertion, random swap, or random deletion. Feature extraction may involve methods like TF-IDF (Term Frequency-Inverse Document Frequency) to represent the importance of words in a document relative to a corpus.

These preprocessing steps may help standardize the user input, extract relevant features, and create a richer, more diverse dataset for training the machine learning trained model. This potentially enhances its performance in natural language processing tasks, improving its ability to understand and process complex textual information in various contexts.

In some examples, the preprocessed training data are fed into the shared layer 210, where shared features are learned. For example, the word embeddings techniques are used to convert words in the training data into dense vector representations that capture semantic relationships. The shared layer 210 outputs representations of the training data to the one or more task-specific layers (e.g., the first task specific layer 212 and the second task specific layer 214).

Each task-specific layer processes the shared representation of the training data according to the requirements of its respective task, refining the data for specific outputs. During the training phase, the machine learning trained model learns to perform each task by adjusting parameters of the machine learning trained model to minimize losses associated with one or more loss functions corresponding to the different tasks. The multi-task learning approach provides a technical solution as it reduces the costs of training the machine learning trained model for performing different tasks by using a shared layer 210.

The first task specific layer 212 may be used to train the machine learning trained model to engage in an interactive dialogue. For example, the machine learning trained model generates a prompt or a response to keep a conversation with a customer, for example in a banking setting. In some examples, the machine learning trained model is trained to elicit data entries through the interactive dialogue. In some examples, the machine learning trained model generates a follow-up prompt or help text that are contextually appropriate and informative. In some examples, the machine learning trained model is trained to keep generating a next word in the prompt, the follow-up prompt, or the help text until the prompt, the follow-up prompt, or the help text is complete. In some examples, the machine learning trained model determines that the prompt, the follow-up prompt, or the help text is complete based on a predefined token limit (e.g., a predetermined length). In some examples, the machine learning trained model determines that the prompt, the follow-up prompt, or the help text is complete based on a probability threshold indicating that the likelihood of producing a relevant next word is low, signaling an appropriate endpoint.

The machine learning trained model may comprises any neural network architecture suitable for maintaining the interactive dialogue. In some examples, the training process for engaging in the interactive dialogue 220 includes optimizing the ability of the machine learning trained model to generate accurate and contextually appropriate prompts, follow-up prompts, or help text based on the user inputs it receives and the contextual information, enabling the machine learning trained model to maintain context over the course of the interaction with the customer and use the contextual information to make prompts, follow-up prompts, or help text more relevant and personalized.

In some examples, the training data is regularly updated with new user interactions and feedback from real-world usage, which is used to refine the performance of the machine learning trained model. In some examples, the performance of the machine learning trained model related to engaging in the interactive dialogue 220 is improved based on the feedback and improvement data 208. In some examples, the feedback and improvement data 208 is collected through user interactions with the graphical user interface. For example, in the graphical user interface, the user 102 may select options such as upvote and downvote, enabling user 102 to assess the output of the machine learning trained model, with upvotes indicating satisfactory outputs and downvotes indicating unsatisfactory or incorrect outputs. In some other examples, the feedback and improvement data 208 are also generated by an evaluator (e.g., a human evaluator, another AI model) who conduct evaluations of the outputs by the machine learning trained model. The evaluator analyzes the outputs of the machine learning trained model for their relevance, accuracy, and utility, providing an assessment that is included in the feedback and improvement data 208.

The system 108 processes the feedback and improvement data 208 to compute a performance score that quantifies the effectiveness of the machine learning trained model. The performance of the machine learning trained model can be optimized based on the performance score. For example, the machine learning trained model is optimized by either maximizing the satisfaction score, which aggregates positive feedback, or by minimizing a performance score that reflects the frequency of unsatisfactory outputs.

In some examples, the system 108 employs an additional machine learning model that analyzes the feedback and improvement data 208 to identify a prevalent issue or a pattern in an output of the machine learning trained model. Based on this analysis, the training process of the machine learning trained model may be adjusted, such as the usage of targeted training data, modification of parameters, or changing the machine learning architecture to enhance performance.

In some examples, the machine learning trained model is optimized via adaptive learning. For example, the machine learning trained model is trained in real-time in response to the system 108 receiving incoming feedback and improvement data 208, allowing the machine learning trained model to improve in real-time as it is interacting with the user 102 to aligned with user expectations and preferences.

The second task specific layer 214 trains the machine learning trained model to perform classification 222. Performing classification 222 includes identifying user intention, extracting data entries needed, or mapping data entries to relevant data fields in the database (e.g., customer database 126). In some examples, the machine learning trained model may be trained by one or more additional task specific layers to perform the user intention identification, the data entry extraction, or data entry mapping. In some examples, the machine learning trained model is trained to identify the user intention based on the user inputs. Based on the user intention, the machine learning trained model stores data entries under the appropriate data fields in the customer database 126. For example, based on the user inputs, the machine learning trained model understands that the user intention is to open a trust account, and based on the user intention, the machine learning trained model classifies the “Jane Doe Revocable Trust” that appeared in the user input as a data field named “trust name. ” Based on the classification, the machine learning trained model stores “Jane Doe Revocable Trust” under the “trust name”of the customer database 126.

In some examples, to perform classification 222, the machine learning trained model calculates one or more matching scores associated with one or more user intentions. In some examples, the machine learning trained model calculates one or more probabilities of one or more data entries being associated with one or more data fields. This probabilistic approach allows the machine learning trained model to predict user intentions and associate data entries based on ranking of the one or more matching scores. For example, when a user inputs a sentence such as “My name is Jane Doe, and the trust name is ‘Jane Doe Revocable Trust.’” the machine learning trained model associates a probability to each segment of the sentence. The machine learning trained model predicts that the term “Jane Doe” is 90% likely to be associated with the data fields for “first name” and “last name,” but only 20% likely to be associated with the “trust name.” Conversely, the machine learning trained model might assess that “Jane Doe Revocable Trust” has an 80% probability of being associated with the “trust name” data field and only a 5% likelihood of relating to an “address” data field.

The second task specific layer 214 may utilize any appropriate neural network architecture. In some examples, the second task specific layer 214 comprises a combination of convolutional neural networks (CNNs) and recurrent neural networks (RNNs), which are effective for capturing both the local features of the text data (such as specific terms that are indicative of certain intents) and the sequential nature of language (such as the order of words and their context within a sentence). The architecture allows the machine learning trained model to classify various user intents and the specific data requirements associated with each user intention.

In some examples, during the training phase, the machine learning trained model is iteratively adjusted to enhance its performance in identifying user intentions and accurately extracting and classifying the one or more data entries into correct data fields. The adjustment process includes continuously refining the machine learning trained model based on one or more dynamically calculated losses. For example, the system 108 generates a loss that reflects the accuracy of the data entries extracted by the machine learning trained model against corresponding verified data entries. The corresponding verified data entries may have been verified by cross-referencing the extracted data entries using a different methodology. For example, a first name of the user 102 is verified if the same first name is extracted from a user input and from the image of the driver license of the user. In some examples, the loss is generated based on the discrepancies between the data entries extracted by the machine learning trained model and the corresponding verified data entries. The loss quantifies the discrepancies between the predictions of the machine learning trained model and the verified data, providing a metric that helps evaluate and improve the accuracy of the machine learning trained model. The training process involves tuning the parameters of the machine learning trained model to minimize the loss, thereby enhancing the ability of the machine learning trained model to accurately predict user intentions and associate the extracted data entries with the appropriate data fields.

In some examples, the training continues until the loss transgresses a predetermined threshold, which is set based on the desired accuracy and reliability. The predetermined threshold acts as a benchmark for the performance of the machine learning trained model, ensuring that the machine learning trained model meets the predefined standards. A technical advantage is achieved for performing accurate data intake.

In some examples, the machine learning trained model is a compact language model comprising fewer than one-hundred million parameters.

In some examples, the compact language model leverages a transformer-based architecture optimized for efficiency and speed. This architecture includes self-attention mechanisms that enable the machine learning trained model to focus on relevant parts of the data entries while ignoring irrelevant information, enhancing its ability to draw accurate associations. A technical benefit is presented with the compact nature of the language model, with fewer than one-hundred million parameters, allows for deployment in resource-constrained environments, without sacrificing performance. This efficiency is achieved through model pruning, quantization, and other optimization techniques that reduce the size and computational requirements of the machine learning trained model while preserving its ability to accurately recognize and associate data entries with their corresponding fields. Because the machine learning trained model is compact, it does not require training using external entities, inherently enhancing data security, as all processing and training can occur within a controlled and secure environment. By minimizing reliance on external data sources, the risk of data breaches or unauthorized access is significantly reduced, ensuring that sensitive information such as customer data 204 remains protected throughout the training and/or interaction process.

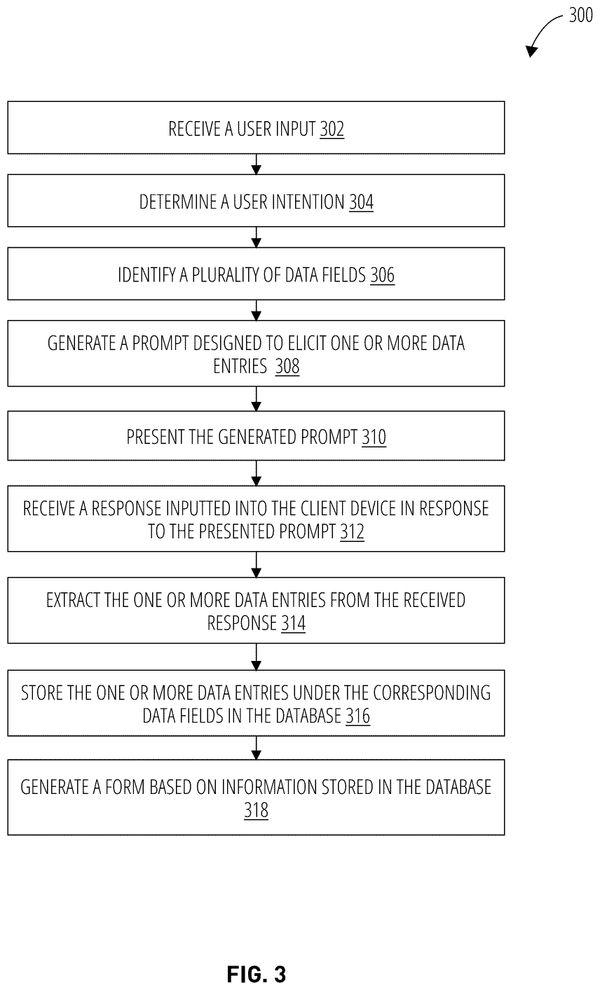

Although each flowchart in FIGS. 3-5 depicts a particular sequence of operations, the sequence may be altered without departing from the scope of the present disclosure. For example, some of the operations depicted may be performed in parallel or in a different sequence that does not materially affect the function of the methods 300, 400, 500, and 600. In other examples, different components of an example device or system that implements the method 300, 400, 500, and 600 may perform functions at substantially the same time or in a specific sequence.

FIG. 3 is a flowchart illustrating an example method 300 for data intake using the machine learning trained model, according to some examples. Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

In block 302, the system 108 receives, from a client device, a user input comprising contextual information of the user input. The user input can be in various forms, such as text entered through the client device, voice captured via a microphone, a gesture captured by the client device, or a selection made through a graphical user interface displayed on the client device. In some examples, the contextual information refers to language, keywords, or content of the user input. The contextual information may be used by the machine learning trained model of the system 108 to determine user interactions. For example, the machine learning trained model is used to identify the service requested by the user or assess the emotional state of the user 102. Based on the identification, the machine learning trained model can generate outputs tailored to the specific situation of the user 102.

In block 304, system 108 determines the user intention based on the contextual information of the user input. In some examples, the contextual information identifies the user intention directly. For example, in the user input, the user 102 indicates a user intention to open a checking account. In some examples, the system 108 determines the user intention based on the contextual information. For example, the contextual information comprises “stock market,” but it is not otherwise clear about what a user intention is with “stock market.” The system 108, using the machine learning trained model, predicts the user intention based on which user intentions are commonly associated with the contextual information, “stock market.” In some examples, the machine learning trained model generates one or more matching scores for one or more candidate user intentions based on the contextual information, ranks the one or more matching scores, and selects a predetermined number of candidate user intentions that are likely to be the user intention for the system 108 to help with based on the ranked one or more matching scores. For example, candidate user intentions generated based on “stock market” are opening a brokerage account, opening a retirement account, inquiring about investment products, etc., each of which is associated with a matching score. In some examples, the machine learning trained model of the system 108 generates a prompt confirming the user intention with the user 102 of the client device.

In block 306, the system 108 identifies a plurality of data fields associated with the user intention. In some examples, the system 108 identifies the plurality of data fields needed for completing the user intention. In some examples, the plurality of data fields is identified based on the task information 206. In other examples, the plurality of data fields is identified based on the data fields associated with the user intention in the customer database 126. For example, the user intention is to open a checking account, the plurality of data fields associated with opening the checking account may be: first name, last name, date of birth, social security number, address, and phone number. In other words, the system 108 aims to obtain the data entries corresponding to these data fields. In another example, the user intention is to check account balance, the system 108 identifies the plurality of data fields such as first name, last name, and account balance, which are associated with the user intention to check account balance.

In block 308, the system 108 generates, using a machine learning trained model, based on the contextual information, a prompt designed to elicit one or more data entries corresponding to a subset of the plurality of data fields. In some examples, the machine learning trained model has previously been trained on various conversation data 202 that includes conversations between bank tellers and bank customers. The machine learning trained model generates the prompt mimicking the language used by bank tellers. In some examples, the prompt includes language generated based on the contextual information so that the prompts fit the conversation and sound more human-like.

In block 310, the system 108 causes the client device to present the generated prompt via the interactive channel provider 106. For example, the client device displays graphical user interface of the interactive channel provider 106, and the generated prompt is displayed on the graphical user interface. For example, the system 108 causes the client device to play an audio clip that includes the generated prompt.

In block 312, system 108 receives a response inputted into the client device in response to the presented prompt. In some examples, the user 102 inputs his or her response to the client device, and the system 108 receives his or her response. In some examples, the user 102 interacts with the client device by providing a response that contains the one or more data entries. The response can be in various forms such as text entered through the client device, voice captured via microphone, gestures captured by the client device, or selections made through a graphical user interface displayed on the client device. In some examples, the response is converted to a desired format (e.g., textual format) using the image recognition component 116 and/or the audio recognition component 118.

In block 314, system 108 extracts one or more data entries from the received response using the machine learning trained model. In some examples, the machine learning trained model analyzes the content of the response to identify and classify the one or more data entries corresponding to the subset of data fields. In some examples, the classification component 120 of the machine learning trained model extracts the one or more data entries by parsing text in the response.

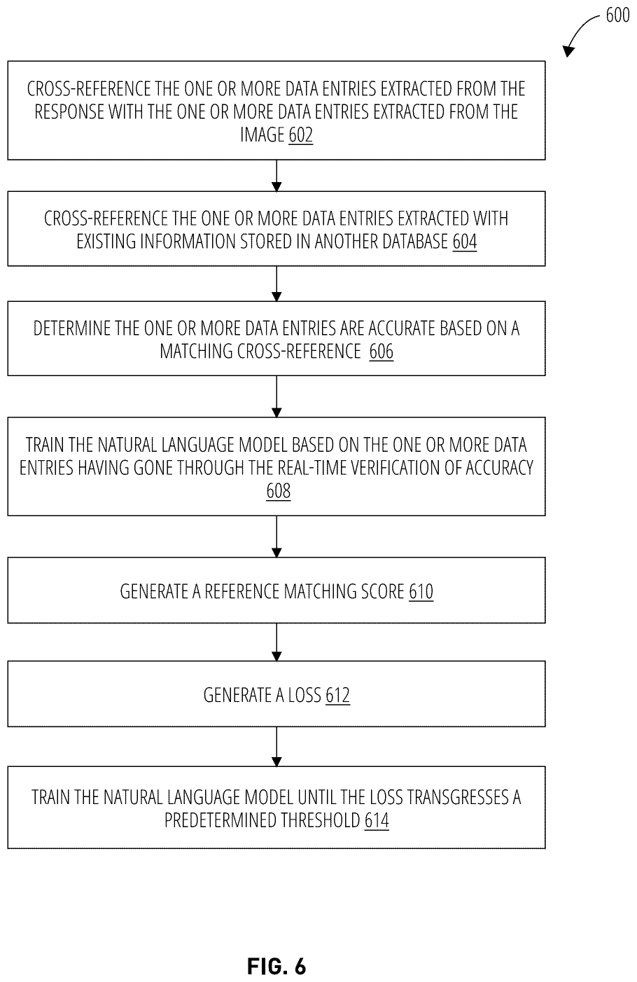

In storing the one or more data entries in the database 316, system 108 stores the one or more data entries under the corresponding data fields in the database. In some examples, the system 108 stores the one or more extracted data entries under the respective data field in the customer database 126 for future processing or querying. In some examples, the storing process may involve updating existing records or creating new entries in the customer database 126. In some examples, when there are existing records in the customer database 126, the verification component 122 verifies the accuracy of the one or more extracted data entries by comparing with the existing records. More about verification of accuracy will be discussed with reference to FIG. 6.

In block 318, system 108 generates a form based on information stored in the customer database 126, the information comprising the one or more data entries. In some examples, the form is used for further administrative processes, reporting, or analysis. The form generation process may include formatting the data according to business rules or regulatory requirements, and preparing it for presentation or export in various formats such as PDF, HTML, or a printed document.

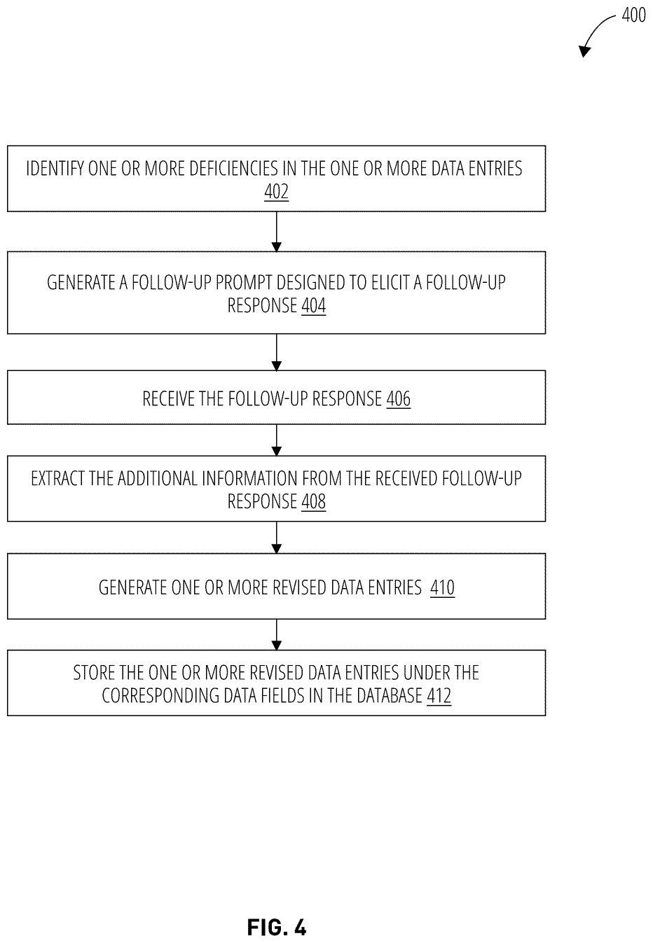

FIG. 4 is a flowchart illustrating an example method 400 for remedying a deficiency, according to some examples.

In block 402, system 108 identifies one or more deficiencies in the one or more data entries using a synonym and spell-checking component or the machine learning trained model. In some examples, identifying the one or more deficiencies includes analyzing the extracted one or more data entries to detect any errors, omissions, or inconsistencies. In some examples, the system 108 causes a verification component 122 to verify the accuracy or completeness of the one or more data entries. In some examples, the system 108 identifies the one or more deficiencies based on validation rules, data integrity checks, or comparison with verified data entries to identify areas that require correction or further clarification. In some examples, the machine learning trained model identifies one or more deficiencies based on none of the one or more probabilities of the one or more data entries being associated with the one or more data fields being higher than a predetermined value, indicating that one or more deficiencies are likely to exist in the user input.

In block 404, system 108 generates, using the machine learning trained model, based on the contextual information of the response, a follow-up prompt designed to elicit a follow-up response comprising additional information that remedies the one or more deficiencies identified by the verification component and/or the machine learning trained model. In some examples, the machine learning trained model has been trained on task information 206, and the follow-up prompt generated by the machine learning trained model comprises a help text generated based on the one or more deficiencies and the task information 206, providing one or more explanations/guidance addressing the one or more deficiencies. For example, if a deficiency identified includes a missing zip code, a missing routing number, and a social security number that is not in the correct format, the follow-up prompt may comprise: “It seems there are a few details we need to correct. Please provide your zip code[,]” “your social security number appears to be formatted incorrectly; please re-enter it in the format XXX-XX-XXXX[,]” and “we noticed the routing number is missing. You can find the routing number at the bottom left corner of your checks, just before your account number.” The follow-up prompt not only informs the user of the errors but also provides an explanation on how to correct them, ensuring the data collected is complete and accurate.

In block 406, system 108 receives the follow-up response inputted into the client device in response to the follow-up prompt. In some examples, similar to the response, the follow-up response may be provided through various input methods.

In block 408, system 108 extracts, using the machine learning trained model, the additional information from the received follow-up response. The machine learning trained model analyzes the follow-up response to identify and extract the additional information that addresses the one or more deficiencies. For example, the user 102 provides additional information that includes the zip code, the routing number, and the corrected social security number. The machine learning trained model extracts each of these additional information for generating one or more revised data entries in block 410.

In block 410, system 108 generates the one or more revised data entries based on the one or more data entries and the additional information. In some examples, the machine learning trained model generates the one or more revised data entries by synthesizing the additional information extracted from the follow-up response and the one or more extracted data entries from the response, thereby remedying the one or more deficiencies and obtaining more accurate and complete data entries. For example, the machine learning trained model combines the address that initially lacked a zip code with the zip code provided in the follow-up response. In some examples, the verification component 122 provides feedback to the machine learning trained model on the accuracy of the one or more revised data entries.

In block 412, system 108 stores the one or more revised data entries under the corresponding data fields in the customer database 126. In some examples, system 108 replaces the data entries previous stored in the customer database 126 with the one or more revised data entries.

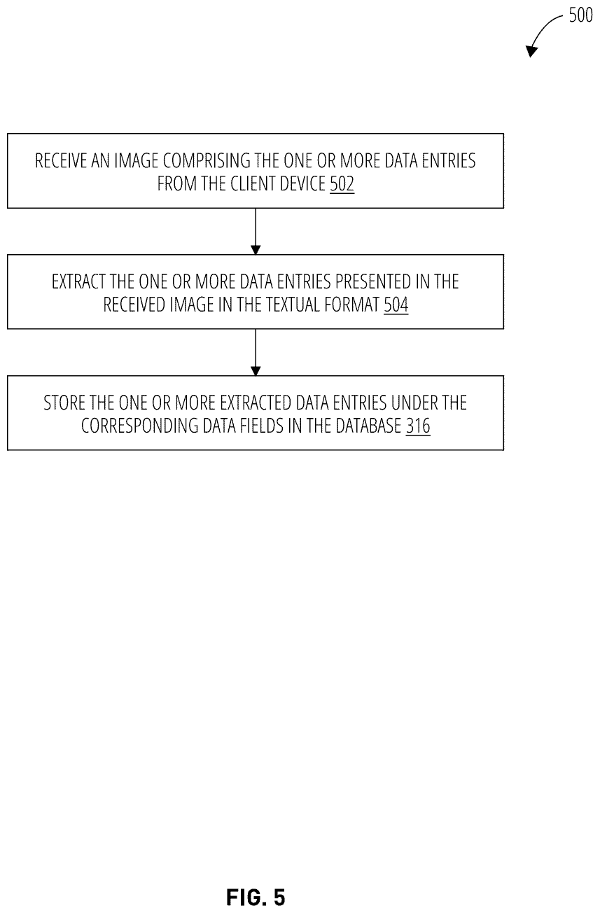

FIG. 5 is a flowchart illustrating an example method 500 for extracting data entries from an image, according to some examples.

In block 502, system 108 receives an image comprising the one or more data entries from the client device. In some examples, the image is transmitted from the client device to the system 108 via the interactive channel provider 106. The image may be a photograph of a document, a scanned document, or any digital image containing textual information that needs to be processed. The system 108 is configured to handle various image formats and resolutions, ensuring compatibility and ease of processing.

In block 504, method 500 converts, using the image recognition component 116, the format of the one or more data entries presented in the received image to textual format. In some examples, the image recognition component 116 is a machine learning model trained on image data containing documents (e.g., documents commonly seen in the banking, legal industry) and the associated text stored in one or more databases (e.g., customer database 126 and task database 128) to develop a specialized optical character recognition capability, which is specialized in detecting and interpreting the text within the image of various documents and outputting textual information in the image.

The image recognition component 116 may be trained to recognize characters and words in different fonts and styles. In some examples, the image recognition component 116 maintains the positions of the text where they were in the image, thereby retaining the information the text are associated with. For example, an address data is next to the heading of the data field “address” in a deed. The image recognition component 116 provides a technical improvement over systems that does not group the texts, and it improves the accuracy of the classification component 120 in associating the data entries with their corresponding data fields.

This process converts the visual representation of the text into a digital textual format that can be further processed and analyzed by other components of the system 108, such as the classification component 120. In some examples, the system 108 uses the third-party natural language model 114 to extract the one or more data entries from the text that appeared in the image.

In some examples, the system 108 proceeds to storing the one or more data entries in the database 316 in response to the one or more data entries being extracted from the received image.

FIG. 6 is a flowchart illustrating an example method 600 for improving the accuracy of the data intake, according to some examples.

In block 602, the system 108, using the verification component 122, cross-references the one or more data entries extracted from different user inputs. In some examples, the verification component 122 cross-references the one or more data entries extracted from a conversation with the customer with those extracted from the image. For example, if a user provides a set of data entries via text and also uploads an image containing overlapping data entries, the verification component 122 verifies that the set of data entries and the overlapping data entries match, indicating that the data entries were correctly extracted and associated with the corresponding data fields. In some examples, the verification results are included in the feedback and improvement data 208, thereby improving the accuracy of the natural language model 112, image recognition component 116, and/or the classification component 120. In some examples, the cross-referencing is performed in real-time in response to the one or more data entries from different sources become available.

In block 604, the system 108, using the verification component 122, cross-references the extracted data entries with existing information stored in another database (e.g., customer database 126) to validate the extracted data entries against previously stored data to ensure reliability and accuracy. For example, if a user provides a new address, the system 108 checks the new address against an address previously stored in a customer database 126 to confirm changes or correct errors.

In block 606, the system 108 verifies the accuracies of the one or more data entries based on the matching cross-reference results. If the data entries extracted from different sources and/or the existing data entries match, the system 108 determines that the one or more data entries are accurate. In some examples, the system 108 stores one or more verified data entries that have gone through accuracy verification in the customer database 126. Method 600 helps maintain the integrity of the information within the system 108 and ensuring that verified and accurate information is used in subsequent processes.

In block 608, the system 108 updates the training data with the one or more verified data entries. The training process for the machine learning trained model further involves updating the parameters of the machine learning trained model to improve its processing of user inputs in the future.

In block 610, the system 108 generates a reference matching score, which quantifies the degree of match between the one or more extracted data entries and the one or more verified data entries. The reference matching score helps assess the similarity and consistency of the data entries obtained from different sources or with the existing database, providing a quantitative measure that can be used for further evaluation.

In block 612, the system 108 generates a loss, which is a measure of the error or discrepancy in the data entries or classification made by the machine learning trained model.

The loss provides feedback on the performance of the machine learning trained model in accuracy of its classification 222. The second loss guides the optimization of the parameters of the machine learning trained model.

In block 614, system 108 trains the machine learning trained model until the loss transgresses a predetermined threshold. By continuously adjusting the parameters of the machine learning trained model and re-evaluating the performance of the machine learning trained model until the loss is reduced to the predetermined threshold, indicating that the model has achieved the desired accuracy and reliability. This iterative training process ensures that the model is well-tuned and capable of handling the specific data processing tasks effectively.

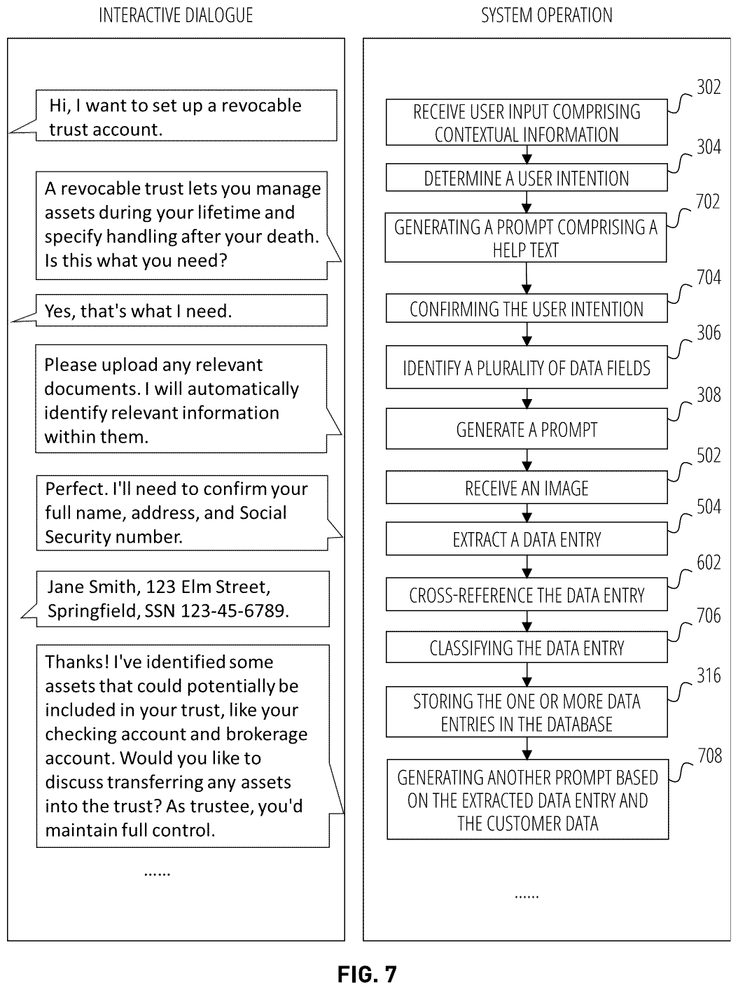

FIG. 7 is a conceptual diagram illustrating an example interactive dialogue between a customer and the system 108, according to some examples. FIG. 7 depicts an example series of interactive dialogues between the user 102 and the system 108, alongside the corresponding system operations occurring at substantially the same time behind the scenes.

The example series of interactions includes a user input by the customer. The user input comprises contextual information. For example, the user input comprises: “Hi, I want to set up a revocable trust account.” The corresponding system operation includes receiving user input comprising contextual information as described with reference to block 302 and determining a user intention as described with reference to block 304.

In some examples, the system operations include generating a prompt comprising a help text 702. The help text provides information about revocable trusts, stating: “A revocable trust lets you manage assets during your lifetime and specify handling after your death.” In block 704, the system 108 confirms the user intention with the customer by asking the user 102: “Is this what you need?” The user 102 confirms the user intention by saying: “Yes, that's what I need.” In some examples, the confirmation by the customer is used as feedback and improvement data 208 to train the machine learning trained model in classifying a user intention.

In response to identifying the user intention, the system 108 identifies a plurality of data fields associated with the user intention as described with respect to block 306.

The system 108 generates a prompt as in block 308 in response to identifying the identify the plurality of data fields. The prompt is designed to elicit one or more data entries corresponding to the identified plurality of data fields. In the example illustrated in FIG. 7, the system 108 prompts the user 102 to upload any relevant documents, stating: “[p]lease upload any relevant documents. I will automatically identify relevant information within them.” In some examples, the user may upload an identification card, a deed, or a tax form.

In the example illustrated in FIG. 7, in response to the prompt, the user 102 uploads a bank statement including the bank account information. The system 108 receives the image comprising the bank statement accordingly as described with reference to block 502.

The system 108 extracts the one or more data entries as described with reference to block 504.

In some examples, the system 108 generates and presents an additional prompt that reads, “Perfect. I'll need to confirm your full name, address, and Social Security number.” (The corresponding system operation is not shown in FIG. 7). The user 102 may respond with the information requested, stating: “Jane Smith, 123 Elm Street, Springfield, SSN 123-45-6789.” In some examples, the system 108 cross-references the one or more data entries with the information provided by the user 102 as described with reference to block 602. In some examples, the system 108 cross-references the one or more data entries as described with reference to block 604. For the example in FIG. 7, the system 108 cross-references the full name and address on the bank statement with those provided by the user in a later interactive dialogue. The system 108 cross-references the social security number indicated by the customer data 204 with the social security number (SSN) provided in the later interactive dialogue.

In some examples, the system 108 classifies the one or more data entries into the corresponding data fields. In some examples, the extraction and the classification of the one or more data entries are implemented as one step.

In some examples, the system 108 stores the one or more verified data entries in the database (e.g., customer data 204).

In the example illustrated in FIG. 7, the system 108 generates another prompt to gather more information corresponding to the subset of the data fields needed to satisfy the user intention to open a revocable trust account, asking: “Thanks! I've identified some assets that could potentially be included in your trust, like your checking account and brokerage account. Would you like to discuss transferring any assets into the trust? As trustee, you'd maintain full control.” In this example, the system 108, by performing the classification 222, determines the checking account and brokerage account shown in the uploaded bank statement may potentially be associated with a data field (e.g., trust asset). The system 108 generates the another prompt to elicit more relevant information regarding the data field. In this example, the another prompt includes another help text (e.g., “As trustee, you'd maintain full control [of the assets].”). For the sake of brevity, FIG. 7 does not show the full interaction and all the system operations. The sequence of the system operations may be altered and additional steps may be added without departing from the scope of the present disclosure. For example, some of the system operations depicted may be performed in parallel or in a different sequence that does not materially affect the function of the routine. In other examples, the system 108 may perform these system operations at substantially the same time or in a specific sequence.

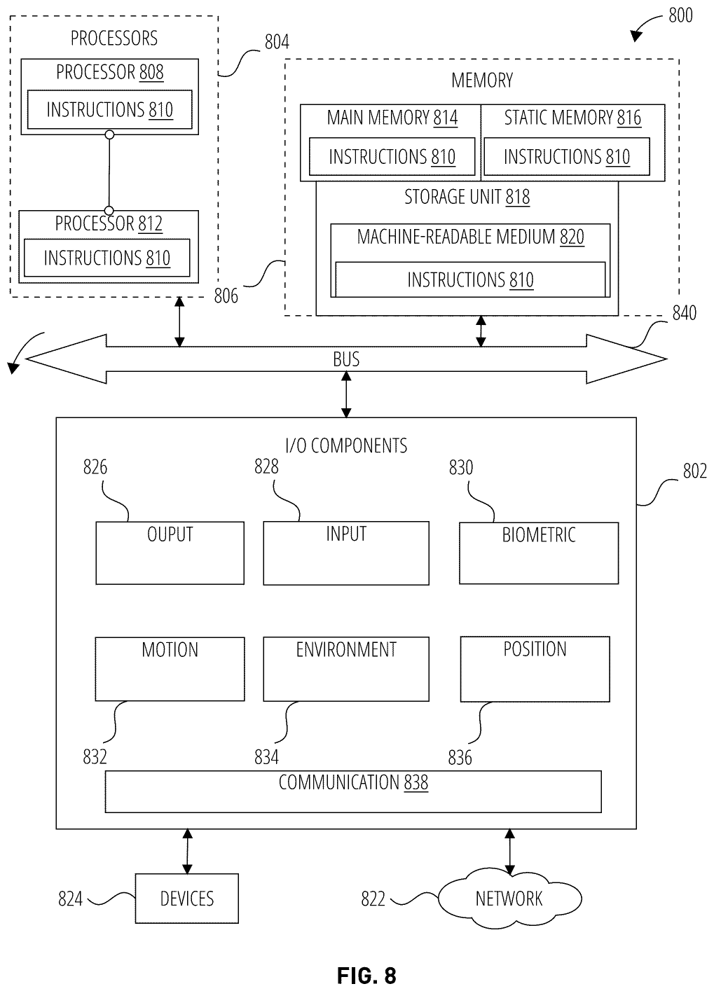

FIG. 8 is a diagrammatic representation of the machine 800 within which instructions 810 (e.g., software, a program, an application, an applet, an app, or other executable code) for causing the machine 800 to perform any one or more of the methodologies discussed herein may be executed. For example, the instructions 810 may cause the machine 800 to execute any one or more of the methods described herein. The instructions 810 transform the general, non-programmed machine 800 into a particular machine 800 programmed to carry out the described and illustrated functions in the manner described. The machine 800 may operate as a standalone device or be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 810, sequentially or otherwise, that specify actions to be taken by the machine 800. Further, while a single machine 800 is illustrated, the term “machine” may include a collection of machines that individually or jointly execute the instructions 810 to perform any one or more of the methodologies discussed herein. The client device may be implemented as a machine 800. The interactive channel provider 106 may comprise one or more machines 800. The system 108 may also be implemented using one or more machines 800.

The machine 800 may include processors 804, memory 806, and I/O components 802, which may be configured to communicate via a bus 840. In some examples, the processors 804 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 808 and a Processor 812 that execute the instructions 810. The term “Processor” is intended to include multi-core processors that may comprise two or more independent processors (sometimes referred to as “cores”) that may execute instructions contemporaneously. Although FIG. 8 shows multiple processors 804, the machine 800 may include a single processor with a single core, a single processor with multiple cores (e.g., a multi-core processor), multiple processors with a single core, multiple processors with multiples cores, or any combination thereof.

The memory 806 includes a main memory 814, a static memory 816, and a storage unit 818, both accessible to the processors 804 via the bus 840. The main memory 806, the static memory 816, and storage unit 818 store the instructions 810 embodying any one or more of the methodologies or functions described herein. The instructions 810 may also reside, wholly or partially, within the main memory 814, within the static memory 816, within machine-readable medium 820 within the storage unit 818, within the processors 804 (e.g., within the processor's cache memory), or any suitable combination thereof, during execution thereof by the machine 800.

The I/O components 802 may include various components to receive input, provide output, produce output, transmit information, exchange information, or capture measurements. The specific I/O components 802 included in a particular machine depend on the type of machine. For example, portable machines such as mobile phones may include a touch input device or other such input mechanisms, while a headless server machine will likely not include such a touch input device. The I/O components 802 may include many other components not shown in FIG. 8. In various examples, the I/O components 802 may include output components 826 and input components 828. The output components 826 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 828 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 802 may include biometric components 830, motion components 832, environmental components 834, or position components 836, among a wide array of other components. For example, the biometric components 830 include components to detect expressions (e.g., hand expressions, facial expressions, vocal expressions, body gestures, or eye-tracking), measure biosignals (e.g., blood pressure, heart rate, body temperature, perspiration, or brain waves), or identify a person (e.g., voice identification, retinal identification, facial identification, fingerprint identification, or electroencephalogram-based identification). The motion components 832 include acceleration sensor components (e.g., accelerometer), gravitation sensor components, rotation sensor components (e.g., gyroscope). The environmental components 834 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 836 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 802 further include communication components 838 operable to couple the machine 800 to a network 822 or devices 824 via respective coupling or connections. For example, the communication components 838 may include a network interface Component or another suitable device to interface with the network 822. In further examples, the communication components 838 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 824 may be another machine or any of a wide variety of peripheral devices (e.g., a peripheral device coupled via a USB).

Moreover, the communication components 838 may detect identifiers or include components operable to detect identifiers. For example, the communication components 838 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF817, Ultra Code, UCC RSS-2D bar code, and other optical codes), or acoustic detection components (e.g., microphones to identify tagged audio signals). In addition, a variety of information may be derived via the communication components 838, such as location via Internet Protocol (IP) geolocation, location via Wi-Fi® signal triangulation, or location via detecting an NFC beacon signal that may indicate a particular location.

The various memories (e.g., main memory 814, static memory 816, and/or memory of the processors 808) and/or storage unit 818 may store one or more sets of instructions and data structures (e.g., software) embodying or used by any one or more of the methodologies or functions described herein. These instructions (e.g., the instructions 810), when executed by processors 804, cause various operations to implement the disclosed examples.

The instructions 810 may be transmitted or received over the network 822, using a transmission medium, via a network interface device (e.g., a network interface component included in the communication components 838) and using any one of several well-known transfer protocols (e.g., hypertext transfer protocol (HTTP)). Similarly, the instructions 810 may be transmitted or received using a transmission medium via a coupling (e.g., a peer-to-peer coupling) to the devices 824.

### Additional Notes

The above detailed description includes references to the accompanying drawings, which form a part of the detailed description. The drawings show, by way of illustration, specific embodiments that may be practiced. These embodiments are also referred to herein as “examples. ”Such examples may include elements in addition to those shown or described.

However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more. ” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein. ” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

### Example Section

Example 1 is a method, comprising: receiving, from a client device, a user input comprising contextual information of the user input; determining, using processing circuitry, a user intention based on the contextual information of the user input; identifying a plurality of data fields associated with the user intention in a database; generating, using a machine learning trained model, based on the contextual information, a prompt designed to elicit a data entry corresponding to a data field of the plurality of data fields; outputting the generated prompt for presentation in the client device; receiving a response from the client device in response to the prompt; extracting, using the machine learning trained model, the data entry from the received response; and storing the data entry under the corresponding data field in the database.

In Example 2, the subject matter of Example 1 includes, identifying a deficiency in the data entry; generating, using the machine learning trained model, based on the contextual information of the response, a follow-up prompt designed to elicit a follow-up response comprising additional information that remedies the deficiency; outputting the generated follow-up prompt for presentation of in the client device; receiving the follow-up response inputted into the client device in response to the follow-up prompt; extracting, using the machine learning trained model, the additional information from the received follow-up response; generating a revised data entry based on the data entry and the additional information; and storing the revised data entry under the corresponding data field in the database.

In Example 3, the subject matter of Example 2 includes, wherein: the machine learning trained model has been trained on explanatory content associated with the user intention and the plurality of the data fields; and the prompt comprises a help text generated using the machine learning trained model based on the contextual information of the user input, the help text providing guidance on the data field.

In Example 4, the subject matter of Example 3 includes, wherein: the explanatory content is associated with the deficiency; the help text is a first help text; and the follow-up prompt comprises a second help text, the second help text provides one or more explanations addressing the deficiency.

In Example 5, the subject matter of Examples 1-4 includes, wherein: the prompt, the response, and the data entry are in an audio format; and the extracting the data entry from the received response comprises: converting the response from the audio format to a textual format using an audio recognition component; and extracting, using the machine learning trained model, the data entry from the response in the textual format.

In Example 6, the subject matter of Examples 1-5 includes, receiving an image comprising the data entry from the client device; extracting, using the machine learning trained model, the data entry presented in the received image in a textual format; and storing the extracted data entry under the corresponding data field in the database.

In Example 7, the subject matter of Example 6 includes, performing a real-time verification of accuracy of the data entry, the real-time verification of accuracy comprises: cross-referencing the extracted data entry from the response with the extracted data entry from the image in response to the extracted data entry from the image becoming available; cross-referencing the extracted data entry with existing information stored in another database; and determining the data entry is accurate based on a matching cross-reference.

In Example 8, the subject matter of Example 7 includes, training the machine learning trained model based on the data entry having gone through the real-time verification of accuracy.

In Example 9, the subject matter of Example 8 includes, generating a reference matching score based on the data entry having gone through the real-time verification of accuracy and the corresponding data field in the database; generating a loss based on the reference matching score and a predicted matching score generated by the machine learning trained model; and training the machine learning trained model until the loss transgresses a predetermined threshold.

In Example 10, the subject matter of Examples 1-9 includes, wherein the machine learning trained model is a compact language model comprising fewer than one-hundred million parameters, and the machine learning trained model being trained to recognize associations between the data entry and the corresponding data field.

Example 11 is a computing system comprising: a processor; and a memory storing instructions that, when executed by the processor, configure the computing system to perform operations comprising: receiving, from a client device, a user input comprising contextual information of the user input; determining, using processing circuitry, a user intention based on the contextual information of the user input; identifying a plurality of data fields associated with the user intention in a database; generating, using a machine learning trained model, based on the contextual information, a prompt designed to elicit a data entry corresponding to a data field of the plurality of data fields; outputting the generated prompt for presentation in a client device; receiving a response from the client device in response to the prompt; extracting, using the machine learning trained model, the data entry from the received response; and storing the data entry under the corresponding data field in the database.

In Example 12, the subject matter of Example 11 includes, wherein the instructions further configure the computing system to perform the operations comprising: identifying a deficiency in the data entry; generating, using the machine learning trained model, based on the contextual information of the response, a follow-up prompt designed to elicit a follow-up response comprising additional information that remedies the deficiency; outputting the generated follow-up prompt for presentation of in the client device; receiving the follow-up response inputted into the client device in response to the follow-up prompt; extracting, using the machine learning trained model, the additional information from the received follow-up response; generating a revised data entry based on the data entry and the additional information; and storing the revised data entry under the corresponding data field in the database.

In Example 13, the subject matter of Example 12 includes, wherein: the machine learning trained model has been trained on explanatory content associated with the user intention and the plurality of the data fields; and the prompt comprises a help text generated using the machine learning trained model based on the contextual information of the user input, the help text providing guidance on the data field.

In Example 14, the subject matter of Example 13 includes, wherein: the explanatory content is associated with the deficiency; the help text is a first help text; and the follow-up prompt comprises a second help text, the second help text provides one or more explanations address the one or more deficiencies.

In Example 15, the subject matter of Examples 11-14 includes, wherein: the prompt, the response, and the data entry are in an audio format; and the extracting the data entry from the received response comprises: converting the response from the audio format to a textual format using an audio recognition component; and extracting, using the machine learning trained model, the data entry from the response in the textual format.

In Example 16, the subject matter of Examples 11-15 includes, wherein the instructions further configure the computing system to perform the operations comprising: receiving an image comprising the data entry from the client device; extracting, using the machine learning trained model, the data entry presented in the received image in a textual format; and storing the extracted data entry under the corresponding data field in the database.

In Example 17, the subject matter of Example 16 includes, wherein the instructions further configure the computing system to perform a real-time verification of accuracy of the data entry, the real-time verification of accuracy comprising: cross-referencing the extracted data entry from the response with the extracted data entry from the image in response to the extracted data entry from the image becoming available; cross-referencing the extracted data entry with existing information stored in another database; and determining the data entry is accurate based on a matching cross-reference.

In Example 18, the subject matter of Example 17 includes, wherein the instructions further configure the computing system to perform the operations further comprising: training the machine learning trained model based on the data entry having gone through the real-time verification of accuracy.

In Example 19, the subject matter of Example 18 includes, wherein the instructions further configure the computing system to perform the operations comprising: generating a reference matching score based on the data entry having gone through the real-time verification of accuracy and the corresponding data field in the database; generating a loss based on the reference matching score and a predicted matching score generated by the machine learning trained model; and training the machine learning trained model until the loss transgresses a predetermined threshold.

Example 20 is a non-transitory computer-readable storage medium, the non-transitory computer-readable storage medium including instructions that when executed by at least one processor, cause the at least one processor to perform operations comprising: receiving, from a client device, a user input comprising contextual information of the user input; determining, using processing circuitry, a user intention based on the contextual information of the user input; identifying a plurality of data fields associated with the user intention in a database; generating, using a machine learning trained model, based on the contextual information, a prompt designed to elicit a data entry corresponding to a data field of the plurality of data fields; outputting the generated prompt for presentation in the client device; receiving a response from the client device in response to the prompt; extracting, using the machine learning trained model, the data entry from the received response; and storing the data entry under the corresponding data field in the database.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A method, comprising:
receiving, from a client device, a user input comprising contextual information of the user input;
determining, using processing circuitry, a user intention based on the contextual information of the user input;
identifying a plurality of data fields associated with the user intention in a database;
generating, using a machine learning trained model, based on the contextual information, a prompt designed to elicit a data entry corresponding to a data field of the plurality of data fields;
outputting the generated prompt for presentation in the client device;
receiving a response from the client device in response to the prompt;
extracting, using the machine learning trained model, the data entry from the received response; and
storing the data entry under the corresponding data field in the database.

2. The method of claim 1, further comprising:
identifying a deficiency in the data entry;
generating, using the machine learning trained model, based on the contextual information of the response, a follow-up prompt designed to elicit a follow-up response comprising additional information that remedies the deficiency;
outputting the generated follow-up prompt for presentation of in the client device;
receiving the follow-up response inputted into the client device in response to the follow-up prompt;
extracting, using the machine learning trained model, the additional information from the received follow-up response;
generating a revised data entry based on the data entry and the additional information; and
storing the revised data entry under the corresponding data field in the database.

3. The method of claim 2, wherein:
the machine learning trained model has been trained on explanatory content associated with the user intention and the plurality of the data fields; and
the prompt comprises a help text generated using the machine learning trained model based on the contextual information of the user input, the help text providing guidance on the data field.

4. The method of claim 3, wherein:
the explanatory content is associated with the deficiency;
the help text is a first help text; and
the follow-up prompt comprises a second help text, the second help text provides one or more explanations addressing the deficiency.

5. The method of claim 1, wherein:
the prompt, the response, and the data entry are in an audio format; and
the extracting the data entry from the received response comprises:
converting the response from the audio format to a textual format using an audio recognition component; and
extracting, using the machine learning trained model, the data entry from the response in the textual format.

6. The method of claim 1, further comprising:
receiving an image comprising the data entry from the client device;
extracting, using the machine learning trained model, the data entry presented in the received image in a textual format; and
storing the extracted data entry under the corresponding data field in the database.

7. The method of claim 6, further comprising performing a real-time verification of accuracy of the data entry, the real-time verification of accuracy comprises:
cross-referencing the extracted data entry from the response with the extracted data entry from the image in response to the extracted data entry from the image becoming available;
cross-referencing the extracted data entry with existing information stored in another database; and
determining the data entry is accurate based on a matching cross-reference.

8. The method of claim 7, further comprising training the machine learning trained model based on the data entry having gone through the real-time verification of accuracy.

9. The method of claim 8, further comprising:
generating a reference matching score based on the data entry having gone through the real-time verification of accuracy and the corresponding data field in the database;
generating a loss based on the reference matching score and a predicted matching score generated by the machine learning trained model; and
training the machine learning trained model until the loss transgresses a predetermined threshold.

10. The method of claim 1, wherein the machine learning trained model is a compact language model comprising fewer than one-hundred million parameters, and the machine learning trained model being trained to recognize associations between the data entry and the corresponding data field.

11. A computing system comprising:
a processor; and
a memory storing instructions that, when executed by the processor, configure the computing system to perform operations comprising:
receiving, from a client device, a user input comprising contextual information of the user input;
determining, using processing circuitry, a user intention based on the contextual information of the user input;
identifying a plurality of data fields associated with the user intention in a database;
generating, using a machine learning trained model, based on the contextual information, a prompt designed to elicit a data entry corresponding to a data field of the plurality of data fields;
outputting the generated prompt for presentation in a client device;
receiving a response from the client device in response to the prompt;
extracting, using the machine learning trained model, the data entry from the received response; and
storing the data entry under the corresponding data field in the database.

12. The computing system of claim 11, wherein the instructions further configure the computing system to perform the operations comprising:
identifying a deficiency in the data entry;
generating, using the machine learning trained model, based on the contextual information of the response, a follow-up prompt designed to elicit a follow-up response comprising additional information that remedies the deficiency;
outputting the generated follow-up prompt for presentation of in the client device;
receiving the follow-up response inputted into the client device in response to the follow-up prompt;
extracting, using the machine learning trained model, the additional information from the received follow-up response;
generating a revised data entry based on the data entry and the additional information; and
storing the revised data entry under the corresponding data field in the database.

13. The computing system of claim 12, wherein:
the machine learning trained model has been trained on explanatory content associated with the user intention and the plurality of the data fields; and
the prompt comprises a help text generated using the machine learning trained model based on the contextual information of the user input, the help text providing guidance on the data field.

14. The computing system of claim 13, wherein:
the explanatory content is associated with the deficiency;
the help text is a first help text; and
the follow-up prompt comprises a second help text, the second help text provides one or more explanations address the one or more deficiencies.

15. The computing system of claim 11, wherein:
the prompt, the response, and the data entry are in an audio format; and
the extracting the data entry from the received response comprises:
converting the response from the audio format to a textual format using an audio recognition component; and
extracting, using the machine learning trained model, the data entry from the response in the textual format.

16. The computing system of claim 11, wherein the instructions further configure the computing system to perform the operations comprising:
receiving an image comprising the data entry from the client device;
extracting, using the machine learning trained model, the data entry presented in the received image in a textual format; and
storing the extracted data entry under the corresponding data field in the database.

17. The computing system of claim 16, wherein the instructions further configure the computing system to perform a real-time verification of accuracy of the data entry, the real-time verification of accuracy comprising:
cross-referencing the extracted data entry from the response with the extracted data entry from the image in response to the extracted data entry from the image becoming available;
cross-referencing the extracted data entry with existing information stored in another database; and
determining the data entry is accurate based on a matching cross-reference.

18. The computing system of claim 17, wherein the instructions further configure the computing system to perform the operations further comprising:
training the machine learning trained model based on the data entry having gone through the real-time verification of accuracy.

19. The computing system of claim 18, wherein the instructions further configure the computing system to perform the operations comprising:
generating a reference matching score based on the data entry having gone through the real-time verification of accuracy and the corresponding data field in the database;
generating a loss based on the reference matching score and a predicted matching score generated by the machine learning trained model; and
training the machine learning trained model until the loss transgresses a predetermined threshold.

20. A non-transitory computer-readable storage medium, the non-transitory computer-readable storage medium including instructions that when executed by at least one processor, cause the at least one processor to perform operations comprising:
receiving, from a client device, a user input comprising contextual information of the user input;
determining, using processing circuitry, a user intention based on the contextual information of the user input;
identifying a plurality of data fields associated with the user intention in a database;
generating, using a machine learning trained model, based on the contextual information, a prompt designed to elicit a data entry corresponding to a data field of the plurality of data fields;
outputting the generated prompt for presentation in the client device;
receiving a response from the client device in response to the prompt;
extracting, using the machine learning trained model, the data entry from the received response; and
storing the data entry under the corresponding data field in the database.
